(19) United States
(12) Patent Application Publication
(10) Pub. No.: US 2012/0093680 A1
(43) Pub. Date: Apr. 19, 2012

(54) METHOD FOR OBTAINING COPPER POWDERS AND NANOPOWDERS FROM INDUSTRIAL ELECTROLYTES INCLUDING WASTE INDUSTRIAL ELECTROLYTES

(76) Inventors: Przemyslaw Los, Zurawice, (PL); Aneta Lukomska, Warszawa (PL); Anna Plewka, Warszawa (PL)

(21) Appl. No.: 13/257,084

(22) PCT Filed: Mar. 17, 2010
(86) PCT No.: PCT/PL2010/000022

§ 371 Date: Nov. 22, 2011

(30) Foreign Application Priority Data
Mar. 20, 2009 (PL) P-387565

(51) Int. Cl. C22C 9/00; C25D 5/18; C25D 21/12; B82Y 40/00; B82Y 99/00

(52) U.S. Cl. 420/469; 205/104; 204/229.4; 977/777; 977/890

(57) ABSTRACT

The method for obtaining copper powders and nanopowders from industrial electrolytes including waste industrial electrolytes through electrochemical deposition of metallic copper on a cathode consists in using potentiostatic pulse electrolysis without the current direction change or with the current direction change, using the cathode potential value close to the plateau or on the plateau of the current voltage curve on which the plateau of the current potential range is from −0.2 V÷−1 V, and a moveable or static ultramicroelectrode or an array of ultramicroelectrodes made of gold, platinum or stainless steel wire or foil is used as a cathode, whereas metallic copper is used as an anode and the process is carried out at temperature from 18-60° C., and the electrolysis lasts from 0.005 to 60 s. Said method can be used to obtain nanopowders and powders characterised by particle structure and dimension repeatability and purity from 99%+ to 99.999% from waste industrial electrolytes and wastewaters from copper industry and electroplating plants without additional treatment.

The object of the invention is the method for obtaining copper powders from industrial electrolytes, including electrolytes which are the waste products of electroplating process, chemical, mining and smelting industry. Waste waters from the copper electrorefining and electroplating processes can be used in a very wide range.

Nanopowders are products of a very high value and their production and application is an important and developing field.

Copper powders and nanopowders are used as additions to polymers, lubricants, dye, antibacterial agents and microprocessor connections. Nanopowders of copper or its alloys can be used in microelectronics and as sorbents in the radioactive waste purification as well as a catalyst in fuel cells.

Nanopowders can be metal particles, metal oxide or organic complex smaller than a micrometer (at least one linear dimension). Production of nanopowders of a well-defined structure and controlled particles size is significant because of requirements that are to be fulfilled by the materials used in different fields of material engineering

One of the currently used methods for obtaining copper nanopowders is electrochemical reduction method (electrodeposition). Electrolytic manufacturing of nano-structured foil and deposits is presented in other patents.

For example in the patent CN 1710737/2005 copper foil made of copper nano-crystals of a size of about 150 nm has been obtained in the process of direct-current electrolysis in the following conditions: metal cathode, temperature 25-65° C., electrolyte flow rate 0.5-5.0 m/s, cathodic current density 0.5-5.0 A/cm². The electrolyte has been composed of the following additions: 1-15 mg/l thiourea, 1-15 mg/l animal glue, 0.1-5.0 mg/l chloride ions and others.

The electrolytic method has been presented in the patent US 2006/0021878. The presented method for obtaining copper of great hardness and good electrical conductivity consists in pulse electrolysis. The process has been carried out in the following conditions: pH from 0.5 to 0.1; electrolyte—copper sulphate of semi-conductor purity; metal cathode, anode—copper of 99.99% purity, temperature from 15° C. to 30° C.; cathodic pulse time from 10 ms to 50 ms; current switch-off time from 1 to 3 s; cathodic current density from 40 to 100 mA/cm². The solution has been mixed using a magnetic stirrer and consisted of the following additions: animal glue from 0.02 ml/l to 0.2 ml/l and NaCl from 0.2 ml/l to 1 ml/l.

It appears from the above mentioned prior art electrochemical methods for obtaining copper nanopowders that they require costly preparation of substrate (solutions, reagents of appropriate purity, reduction reagents and other reagents). These processes are so complicated and expensive that the nanopowders market prices are very high.

One of the fundamental conditions ensuring technological feasibility and economic viability of metal recovery from industrial electrolytes of low concentration of deposited elements is providing sufficient mass transport rates to the electrode of electrodeposited ions. This way the rate and efficiency of nanopowder production process is increased.

The present invention solves the problem of the necessity of using an electrolyte of appropriate purity and concentration, and of using additional electrolytes and other substances. It has been unexpectedly found out that the copper powders and nanopowders can be obtained from industrial electrolyte solutions including the waste waters if they undergo potentiostatic pulse electrolysis without the current direction change and with the current direction change using ultramicroelectrodes.

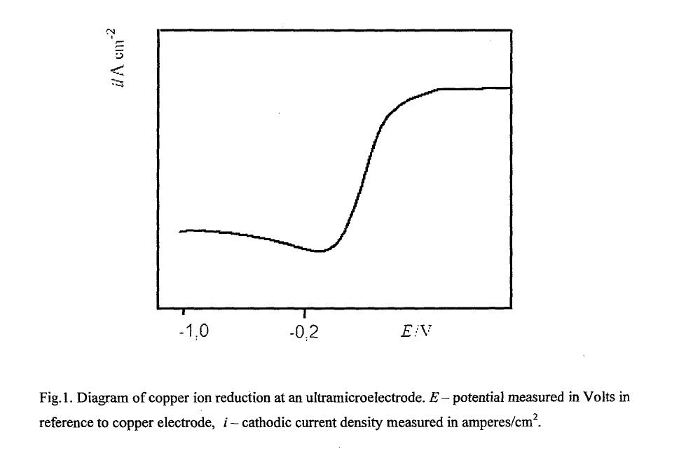

The method for obtaining copper powders and nanopowders from industrial electrolytes and waste waters through electrodeposition of metallic copper on a cathode according to said invention consists in that, that the electrolyte solution of copper ions concentration higher than 0.01 g dm⁻³ undergoes potentiostatic pulse electrolysis without the current direction change or with the current direction change using the cathode potential value close to the plateau or on the plateau of the current voltage curve shown in FIG. 1 on which the plateau of the current potential range is from −0.2 V÷−1V, a moveable or static ultramicroelectrode or an array of ultramicroelectrodes made of gold, platinum or stainless steel wire or foil is used as a cathode, whereas metallic copper is used as an anode and the process is carried out at temperature from 18-60° C., and the electrolysis lasts from 0.005 s to 60 s.

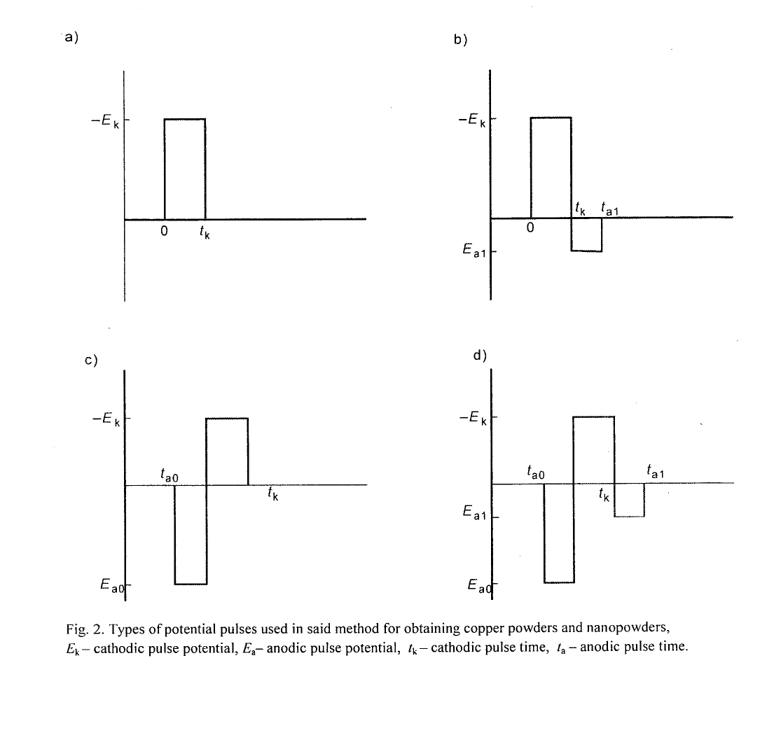

The advantage of the method according to the invention consists in that, that the electrolyte solution undergoes potentiostatic electrolysis as shown in FIG. 2 from a) to d) in which:

FIG. 2a) shows a pulse in cathodic potential Eₖ in the range from −0.2 V÷−1V, in reference to copper electrode, in time tₖ from 0.005 s to 60 s,

FIG. 2b) shows a pulse in cathodic potential Eₖ in the range from −0.2 V÷−1 V, in reference to copper electrode, in time tₖ from 0.005 s to 60 s, and then a pulse in anodic potential Eₐ₁ in the range from 0.0 V÷+1.0 V, in reference to copper electrode, in time tₐ₁ shorter for at least 10% than time tₖ,

FIG. 2c) shows a pulse in anodic potential Eₐ₀ in the range from 0.0 V÷+1.0 V, in reference to copper electrode, in time tₐ₀≦tₖ, and then a pulse in cathodic potential Eₖ in the range from −0.2 V÷−1 V, in reference to copper electrode, in time tₖ from 0.005 s to 60 s,

FIG. 2d) shows a pulse in anodic potential Eₐ₀ in the range from 0.0 V÷+1.0 V, in reference to copper electrode, in time tₐ₀≦tₖ, and then a pulse in cathodic potential Eₖ in the range from −0.2 V÷−1 V, in reference to copper electrode, in time tₖ from 0.005 s to 60 s, and a subsequent pulse in anodic potential Eₐ₁ in time tₐ₁ shorter for at least 10% than tₖ.

Cathodic copper reduction process is controlled by ion diffusion to the electrode which in said method is achieved by using ultramicroelectrodes or an array of ultramicroelectrodes, and carrying out potentiostatic electrolysis at the cathodic potential close to the plateau or on the plateau of the current voltage curve (FIG. 1). Said electrolysis process can be studied using chronoamperometry consisting in current measurement as a function of time at constant potential applied to the electrode.

The diameter of wire ultramicroelectrodes used in said method can be from 1 to 100 μm. The ultramicroelectrode array area can measure from 1·10⁻⁶ cm² to 10000 cm². The area of ultramicroelectrode array in the shape of plates can measure from 1 cm² to 10000 cm².

When moveable electrodes are used the time they remain in the electrolyte is equal to the duration of one electrolysis cycle. When static electrodes are used the time they remain in the electrolyte is equal to the duration of one electrolysis cycle. After each cycle an electrode is removed from the solution and a new electrode is immersed in the electrolyte solution.

The electrolysis product, i.e. powders or nanopowders can be removed from an electrode surface using a jet stream of either inert gas or liquid or it can be removed from an electrode surface mechanically using a sharp-edged gathering device made of Teflon for example.

Using said electrochemical method, copper powders and nanopowders characterised by particle structure and dimension repeatability are obtained from industrial electrolyte solutions including waste industrial electrolytes and wastewaters from copper industry and electroplating plants. Copper nanopowders of 99%+ to 99.999% purity can be obtained using said method from waste industrial electrolytes and wastewaters without additional treatment. It allows to obtain nanopowders on an industrial scale at significantly reduced costs. Using said method, powders or nanopowders of different shapes, structure and dimensions are obtained depending on the size of the electrode, metal the electrode is made of, conditions in which the electrolysis is carried out and particularly the kind of electrolysis (FIG. 2 items a-d), temperature and copper concentration in the electrolyte.

Obtaining copper nanopowders and powders using said method is shown in the examples.

### EXAMPLE I

A platinum wire working ultramicroelectrode a diameter of which is 10 μm, serving as a cathode and a reference electrode (an anode) in the form of a copper plate, the area of which is 0.3 cm² and its thickness is 0.1 cm are placed in an electrochemical cell thermostated up to 25° C. The cell is filled with industrial electrolyte, used in copper electrorefining, composed of 46 g dm⁻³ Cu, 170-200 g dm⁻³ H₂SO₄, Ni, As, Fe (>1000 mg dm⁻³), Cd, Co, Bi, Ca, Mg, Pb, Sb (from 1 mg dm⁻³ to 1000 mg dm⁻³) and Ag, Li, Mn, Pd, Rh (<1 mg dm⁻³) as well as animal glue and thiourea (<1 mg dm⁻³). The electrodes are connected to measuring device—Autolab GSTST30 potentiostat working on-line with a personal computer (PC) with GPES software by Eco Chemie with the aid of a BNC connector.

Parameters of the process have been as follows:
Eₐ₀=0.6 V tₐ₀=0.1 s
Eₖ=−0.4V tₖ=0.1 s

After electrochemical deposition of copper on the electrode the structure and dimensions of deposited powder have been studied using a scanning electron microscope and it has been stated that the obtained deposit is in the shape of tubes of about 250 nm length and about 50-70 nm width. On the basis of the analysis of energy dispersion spectrum (EDS) it has been stated that only lines characteristic of copper are present which shows the purity of the obtained product.

### EXAMPLE II

A platinum wire working ultramicroelectrode a diameter of which is 10 μm, serving as a cathode and a reference electrode (an anode) in the form of a copper plate, the area of which is 0.3 cm² and its thickness is 0.1 cm are placed in an electrochemical cell thermostated up to 25° C. The cell is filled with industrial electrolyte, used in copper electrorefining the composition of which is given in Example I. The electrodes are connected to measuring device—potentiostat working on-line with a personal computer (PC) with special software.

Parameters of the process have been as follows:
Eₐ₀=0.6 V tₐ₀=0.1 s
Eₖ=−0.4 V tₖ=0.125 s

After electrochemical deposition of copper on the electrode the structure and dimensions of deposited powder have been studied using a scanning electron microscope and it has been stated that the obtained deposit is in the shape of tubes of about 600 nm length and about 60-120 nm width. On the basis of the analysis of energy dispersion spectrum (EDS) it has been stated that only lines characteristic of copper are present.

### EXAMPLE III

A platinum wire working ultramicroelectrode a diameter of which is 100 μm, serving as a cathode and a reference electrode (an anode) in the form of a copper plate, the area of which is 0.3 cm² and its thickness is 0.1 cm are placed in an electrochemical cell thermostated up to 25° C. The cell is filled with industrial electrolyte, used in copper electrorefining the composition of which is given in Example I. The electrodes are connected to measuring device—potentiostat working on-line with a personal computer (PC) with special software.

Parameters of the process have been as follows:
Eₐ₀=0.6 V tₐ₀=0.1 s
Eₖ=−0.4 V tₖ=0.1 s

After electrochemical deposition of copper on the electrode the structure and dimensions of deposited powder have been studied using a scanning electron microscope and it has been stated that the obtained deposit is in the shape of large crystallites of about 200 nm-600 nm grain diameter. On the basis of the analysis of energy dispersion spectrum (EDS) it has been stated that only lines characteristic of copper are present.

### EXAMPLE IV

A gold wire working ultramicroelectrode a diameter of which is 10 μm, serving as a cathode and a reference electrode (an anode) in the form of a copper plate, the area of which is 0.3 cm² and its thickness is 0.1 cm are placed in an electrochemical cell thermostated up to 25° C. The cell is filled with industrial electrolyte, used in copper electrorefining the composition of which is given in Example I. The electrodes are connected to measuring device—potentiostat working on-line with a personal computer (PC) with special software.

Parameters of the process have been as follows:
Eₐ₀=0.6 V tₐ₀=0.1 s
Eₖ=−0.4 V tₖ=0.125 s

After electrochemical deposition of copper on the electrode the structure and dimensions of deposited powder have been studied using a scanning electron microscope and it has been stated that the obtained deposit is in the shape of large crystallites of about 150 nm grain diameter. On the basis of the analysis of energy dispersion spectrum (EDS) it has been stated that only lines characteristic of copper are present.

### EXAMPLE V

A gold wire working ultramicroelectrode a diameter of which is 40 μm, serving as a cathode and a reference electrode (an anode) in the form of a copper plate, the area of which is 0.3 cm² and its thickness is 0.1 cm are placed in an electrochemical cell thermostated up to 25° C. The cell is filled with industrial electrolyte, used in copper electrorefining the composition of which is given in Example I. The electrodes are connected to measuring device—potentiostat working on-line with a personal computer (PC) with special software.

Parameters of the process have been as follows:
Eₐ₀=0.6 V tₐ₀=0.1 s
Eₖ=−0.4 V tₖ=0.5 s

After electrochemical deposition of copper on the electrode the structure and dimensions of deposited powder have been studied using a scanning electron microscope and it has been stated that the obtained deposit is in the spherical shape of about 250-300 nm diameter. On the basis of the analysis of energy dispersion spectrum (EDS) it has been stated that only lines characteristic of copper are present.

### EXAMPLE VI

A gold wire working ultramicroelectrode a diameter of which is 40 μm, serving as a cathode and a reference electrode (an anode) in the form of a copper plate, the area of which is 0.3 cm² and its thickness is 0.1 cm are placed in an electrochemical cell thermostated up to 25° C. The cell is filled with industrial electrolyte, used in copper electrorefining the composition of which is given in Example I. The electrodes are connected to measuring device—potentiostat working on-line with a personal computer (PC) with special software.

Parameters of the process have been as follows:
Eₐ₀=0.6 V tₐ₀=0.1 s
Eₖ=−0.5 V tₖ=0.1 s

After electrochemical deposition of copper on the electrode the structure and dimensions of deposited powder have been studied using a scanning electron microscope and it has been stated that the obtained deposit is in the spherical shape of about 250-300 nm diameter. On the basis of the analysis of energy dispersion spectrum (EDS) it has been stated that only lines characteristic of copper are present.

### EXAMPLE VII

A stainless steel wire working ultramicroelectrode a diameter, of which is 25 μm, serving as a cathode and a reference electrode (an anode) in the form of a copper plate, the area of which is 0.3 cm² and its thickness is 0.1 cm are placed in an electrochemical cell thermostated up to 25° C. The cell is filled with industrial electrolyte, used in copper electrorefining the composition of which is given in Example I. The electrodes are connected to measuring device—potentiostat working on-line with a personal computer (PC) with special software.

Parameters of the process have been as follows:
Eₐ=0.6 V tₐ₀=0.1 s
Eₖ=−0.4 V tₖ=0.05 and t=0.075 s

After electrochemical deposition of copper on the electrode the structure and dimensions of deposited powder have been studied using a scanning electron microscope and it has been stated that the obtained deposit is in the spherical shape. The grain diameter is of about 300 nm for t=0.05 s and about 400 nm for t=0.075 s. On the basis of the analysis of energy dispersion spectrum (EDS) it has been stated that only lines characteristic of copper are present.

### EXAMPLE VIII

A stainless steel wire working ultramicroelectrode a diameter of which is 25 μm, serving as a cathode and a reference electrode (an anode) in the form of a copper plate, the area of which is 0.3 cm² and its thickness is 0.1 cm are placed in an electrochemical cell thermostated up to 25° C. The cell is filled with industrial electrolyte, used in copper electrorefining the composition of which is given in Example I. The electrodes are connected to measuring device—potentiostat working on-line with a personal computer (PC) with special software.

Parameters of the process have been as follows:
Eₐ=0.6 V tₐ₀=0.1 s
Eₖ=−0.45 V tₖ=0.05 s and t=0.075 s

After electrochemical deposition of copper on the electrode the structure and dimensions of deposited powder have been studied using a scanning electron microscope and it has been stated that the obtained deposit is in the spherical shape. The grain diameter is of about 200 nm for t=0.05 s and about 550 nm for t=0.075 s. On the basis of the analysis of energy dispersion spectrum (EDS) it has been stated that only lines characteristic of copper are present.

### EXAMPLE IX

A stainless steel wire working ultramicroelectrode a diameter of which is 25 μm, serving as a cathode and a reference electrode (an anode) in the form of a copper plate, the area of which is 0.3 cm² and its thickness is 0.1 cm are immersed in industrial electrolyte as in Example I with Cu content of 46 g dm⁻³ placed in an electrochemical cell thermostated up to 25° C. The electrodes are connected to measuring device—potentiostat working on-line with a personal computer (PC) with special software.

Parameters of the process have been as follows:
Eₐ=0.6 V tₐ₀=0.1 s
Eₖ=−0.5 V tₖ=0.05 s and t=0.075 s

After electrochemical deposition of copper on the electrode the structure and dimensions of deposited powder have been studied using a scanning electron microscope and it has been stated that the obtained deposit is in the spherical shape. The grain diameter is of about 600-700 nm for t=0.05 s and about 700-800 nm for t=0.075 s. On the basis of the analysis of energy dispersion spectrum (EDS) it has been stated that only lines characteristic of copper are present.

### EXAMPLE X

A stainless steel wire working ultramicroelectrode a diameter of which is 25 μm, serving as a cathode and a reference electrode (an anode) in the form of a copper plate, the area of which is 0.3 cm² and its thickness is 0.1 cm are placed in an electrochemical cell thermostated up to 25° C. The cell is filled with industrial electrolyte, used in copper electrorefining the composition of which is given in Example I. The electrodes are connected to measuring device—potentiostat working on-line with a personal computer (PC) with special software.

Parameters of the process have been as follows:
Eₐ=0.6 V tₐ₀=0.1 s
Eₖ=−0.4 V and Eₖ=−0.45 V tₖ=0.1 s

After electrochemical deposition of copper on the electrode the structure and dimensions of deposited powder have been studied using a scanning electron microscope and it has been stated that the obtained deposit is in the spherical shape of distinct structure. The grain diameter is in the range from 200-1200 nm. On the basis of the analysis of energy dispersion spectrum (EDS) it has been stated that only lines characteristic of copper are present.

### EXAMPLE XI

A cathode—a stainless steel plate of an area of about 1 cm² and an anode in the form of a copper plate of an area of 3 cm² and thickness of 0.1 cm are immersed in industrial electrolyte the composition of which is given in Example I. The electrodes are connected to measuring device—potentiostat working on-line with a personal computer (PC) with special software.

Parameters of the process have been as follows:
Eₖ=−0.4 V tₖ=1 s, tₖ=15 s, tₖ=30 s, tₖ=60 s.

After electrochemical deposition of copper on the electrode the structure and dimensions of deposited powder have been studied using a scanning electron microscope and it has been stated that the obtained deposit is in the spherical shape of distinct structure. The sizes of obtained agglomerates are respectively: about 5-10 μm, 2.5-3 μm, 1-2 μm, 0.2-0.5 μm for the following times 60, 30, 15, 1 s respectively. On the basis of the analysis of energy dispersion spectrum (EDS) it has been stated that only lines characteristic of copper are present.

### EXAMPLE XII

A stainless steel wire working ultramicroelectrode a diameter of which is 25 μm, serving as a cathode and a reference electrode (an anode) in the form of a copper plate, the area of which is 0.3 cm² and its thickness is 0.1 cm are placed in an electrochemical cell thermostated up to 25° C. The cell is filled with spent industrial electrolyte, used in copper electrorefining composed of 0.189 g dm⁻³ Cu, 170-200 g dm⁻³ H₂SO₄, Ni, As, Fe (>1000 mg dm⁻³), Cd, Co, Bi, Ca, Mg, Pb, Sb (from 1 mg dm⁻³ to 1000 mg dm⁻³) and Ag, Li, Mn, Pd, Rh (<1 mg dm⁻³) as well as animal glue and thiourea. The electrodes are connected to measuring device—potentiostat working on-line with a personal computer (PC) with special software.

Parameters of the process have been as follows:
Eₖ=−0.40 V tₖ=0.5 s

After electrochemical deposition of copper on the electrode the structure and dimensions of deposited powder have been studied using a scanning electron microscope and it has been stated that the obtained deposit is in the spherical shape of distinct structure. The grain diameter is in the range from 350 nm to 2.5 μm. On the basis of the analysis of energy dispersion spectrum (EDS) it has been stated that only lines characteristic of copper are present.

1. The method for obtaining copper powders and nanopowders from industrial electrolytes including waste industrial electrolytes through electrochemical deposition of copper on a cathode, wherein the electrolyte solution of copper ion concentration higher than 0.01 gm⁻³ undergoes potentiostatic pulse electrolysis, using the cathode potential range of from −0.2V to −1V, in reference to copper electrode; a cathode ultramicroelectrode, the ultramicroelectrode comprising gold, platinum or stainless steel, or an array of ultramicroelectrodes, the ultramicroelectrodes comprising gold, platinum or stainless steel; an anode comprising metallic copper, the process being carried out at temperature of from 18-60° C., and the electrolysis lasting for a period of 0.005 to 60 s.

2. The method according to claim 1, wherein this electrolyte solution undergoes potentiostatic electrolysis according to one or more of the processes which:
a) show a pulse in cathodic potential Eₖ in the range from −0.2V to −1.0V, in reference to copper electrode, in time tₖ from 0.005 s to 60 s,
b) show a pulse in cathodic potential Eₖ in the range from −0.2V to −1.0V, in reference to copper electrode, in time tₖ from 0.005 s to 60 s, and then a pulse in anodic potential Eₐ₁ in the range from 0.0V to +1.0V, in reference to copper electrode, in time tₐ₁ shorter for at least 10% than time tₖ,
c) show a pulse in anodic potential Eₐ₀ in the range from 0.0V to +1.0V, in reference to copper electrode, in time tₐ₀≦tₖ, and then a pulse in cathodic potential Eₖ in the range from −0.2V to −1.0V, in reference to copper electrode, in time tₖ from 0.005ₛ to 60ₛ,
d) show a pulse in anodic potential Eₐ₀ in the range from 0.0V to +1.0V, in reference to copper electrode, in time tₐ₀≦tₖ and then a pulse in cathodic potential Eₖ in the range from −0.2V to −1.0V, in reference to copper electrode, in time tₖ from 0.005ₛ to 60ₛ, and a subsequent pulse in anodic potential Eₐ₁ in time tₐ₁₊ shorter for at least 10% than tₖ.

3. A method according to claim 1, wherein the potentiostatic pulse electrolysis takes place with a change in current direction.

4. A method according to claim 1, wherein the potentiostatic pulse electrolysis takes place without a change in current direction.

5. A method according to claim 1, wherein the potentiostatic pulse electrolysis takes place using the cathode potential value close to the plateau or on the plateau of the current voltage curve.

6. A method according to claim 1, wherein the ultramicroelectrode is a moveable ultramicroelectrode.

7. A method according to claim 1, wherein the ultramicroelectrode is a static ultramicroelectrode.

8. A method according to claim 1, wherein the ultramicroelectrode has an array area of from 1×10⁻⁶ to 10000 cm².

9. A method according to claim 3 wherein the anodic potential Eₐ₀ is about 0.6V.

10. A method according to claim 9 wherein the cathodic potential Eₖ is about −0.4V, −0.45V or −0.5V.

11. A method according to claim 9 wherein the pulse in the anodic potential is for a period (tₐ₀) of about 0.1 s.

12. A method according to claim 10 wherein the cathodic potential Eₖ is about −0.4V, and the pulse in the cathodic potential is for a period (tₖ) of about 0.1 s.

13. A method according to claim 1 wherein the ultramicroelectrode has a diameter of from 1-100 μm,

14. A copper powder or nanopowder obtainable according to the method of claim 1.

15. An apparatus for obtaining copper powders and nanopowders from industrial electrolytes including waste industrial electrolytes through electrochemical deposition of copper on a cathode, comprising an electrolyte solution of copper ion concentration higher than 0.01 gm⁻³; means for providing a potentiostatic pulse electrolysis; a cathode ultramicroelectrode, the ultramicroelectrode comprising gold, platinum or stainless steel, or an array of ultramicroelectrodes, the ultramicroelectrodes comprising gold, platinum or stainless steel; an anode comprising metallic copper; and means for providing a process temperature of from 18-60° C., and means for maintaining the electrolysis from 0.005 to 60 s.
